(19) United States
(12) Patent Application Publication
(10) Pub. No.: US 2017/0293261 A1
(43) Pub. Date: Oct. 12, 2017

(54) STRUCTURED ILLUMINATION MICROSCOPE AND IMAGE PROCESSING METHOD USING THE SAME

(71) Applicant: SAMSUNG DISPLAY CO., LTD., Yongin-si (KR)

(72) Inventor: Hye Sog LEE, Osan-si (KR)

(21) Appl. No.: 15/480,898

(22) Filed: Apr. 6, 2017

(30) Foreign Application Priority Data
Apr. 8, 2016 (KR) 10-2016-0043236

(51) Int. Cl. G03H 1/00; G03H 1/02; G02B 21/02; G02B 21/36; G03H 1/06

(52) U.S. Cl. CPC G03H 1/0005; G02B 21/361; G03H 1/06; G02B 21/025; G03H 1/02; G03H 2001/005; G03H 2001/0212; G03H 2001/0216

(57) ABSTRACT

A structured illumination microscope includes a holographic image generator that generates a holographic image at a position overlapping an observation object. The structured illumination microscope further includes an image sensor that senses an interference image generated by overlapping the observation object with the holographic image. The structured illumination microscope additionally includes an image recovery processor that recovers an image of the observation object by comparing received data of the holographic image to received data of the interference image.

### CROSS-REFERENCE TO RELATED APPLICATION

This application claims priority under 35 U.S.C. §119 to Korean Patent Application No. 10-2016-0043236 filed on Apr. 8, 2016 in the Korean Intellectual Property Office, the disclosure of which is incorporated by reference herein in its entirety.

### Technical Field

Exemplary embodiments of the present inventive concept relate to a high-resolution microscope, and more particularly, to a structured illumination microscope and an image processing method by using the same.

### Discussion of the Related Art

A microscope is a device for magnifying an image of a small object or material that the naked eye cannot see. A minimum distance between two points that can be identified by using microscopy is referred to as resolution.

Some microscopy methods include stimulated emission depletion (STED) microscopy, photoactivated localization microscopy (PALM), structured illumination microscopy (SIM), etc.

A structured illumination microscopy typically processes an observed image by overlapping an observation object pattern and a pattern known by a user, such as a lattice pattern, to generate an interference pattern. The generated interference pattern is referred to as a moiré pattern. Information of the moiré pattern is detected and used to calculate information of the observation object. A higher resolution of the observation object may be obtained by changing the phase of the interface pattern for multiple images of the observation object.

### SUMMARY

According to an exemplary embodiment of the present inventive concept, a structured illumination microscope includes a holographic image generator that generates a holographic image at a position overlapping an observation object. The structured illumination microscope further includes an image sensor that senses an interference image generated by overlapping the observation object with the holographic image. The structured illumination microscope additionally includes an image recovery processor that recovers an image of the observation object by comparing received data of the holographic image to received data of the interference image.

In an exemplary embodiment of the present inventive concept, the holographic image generator includes a light source that provides light and a beam expander that expands a beam width of the light from the light source. The holographic image generator further includes a spatial light modulator that receives the expanded light to generate the holographic image. The holographic image generator additionally includes a controller that transmits a signal to the spatial light modulator to generate the holographic image.

In an exemplary embodiment of the present inventive concept, the holographic image generator further includes a reflector that reflects the light from the light source to overlap the holographic image with the observation object.

In an exemplary embodiment of the present inventive concept, the holographic image generator further includes a condensing lens that reduces the size of the holographic image.

In an exemplary embodiment of the present inventive concept, the light source includes a laser.

In an exemplary embodiment of the present inventive concept, the light source includes a light emitting diode (LED) and a pin hole where the light from the LED passes through.

In an exemplary embodiment of the present inventive concept, the beam expander includes a first lens that effuses the light supplied from the light source to expand the beam width and a second lens that converts the light transmitted from the first lens into parallel light.

In an exemplary embodiment of the present inventive concept, the spatial light modulator includes a transmissive spatial light modulator.

In an exemplary embodiment of the present inventive concept, the transmissive spatial light modulator includes a liquid crystal panel.

In an exemplary embodiment of the present inventive concept, the spatial light modulator includes a reflective spatial light modulator.

In an exemplary embodiment of the present inventive concept, the reflective spatial light modulator includes a Liquid Crystal on Silicon (LCoS) panel or a Digital Micromirror Device (DMD) panel.

In an exemplary embodiment of the present inventive concept, the structured illumination microscope further includes an objective and eyepiece lens that magnifies the interference image that is transmitted to the image sensor.

According to an exemplary embodiment of the present inventive concept, an image processing method includes positioning an observation object on a stage, supplying a light and receiving the light and a signal for generating the holographic image to generate a holographic image. The image processing method further includes positioning the holographic image to overlap the observation object. The image processing method additionally includes sensing an interference image generated by overlapping the observation object with the holographic image. The image processing method further includes recovering an image of the observation object by comparing received data of the holographic image to received data of the interference image.

In an exemplary embodiment of the present inventive concept, the image processing method further includes changing at least one of a pattern direction, a size, and a depth of the holographic image.

In an exemplary embodiment of the present inventive concept, the image processing method further includes expanding a beam width of the light.

In an exemplary embodiment of the present inventive concept, the image processing method further includes reducing the size of the holographic image.

In an exemplary embodiment of the present inventive concept, the image processing method further includes magnifying the interference image.

In an exemplary embodiment of the present inventive concept, a spatial light modulator generates the holographic image.

In an exemplary embodiment of the present inventive concept, the spatial light modulator includes a transmissive spatial light modulator or a reflective spatial light modulator.

In an exemplary embodiment of the present inventive concept, the spatial light modulator includes at least one of a liquid crystal panel, a Liquid Crystal on Silicon (LCoS) panel, and a Digital Micromirror Device (DMD) panel.

### BRIEF DESCRIPTION OF THE DRAWINGS

The above and other features of the present inventive concept will become more apparent by describing in detail exemplary embodiments thereof, with reference to the accompanying drawings, in which:

FIG. 1A is a view showing an observation object in a comparative example;

FIG. 1B is a view showing a lattice pattern in a comparative example;

FIG. 1C is a view showing an interference pattern in a comparative example;

FIG. 2 is a view showing a structured illumination microscope according to an exemplary embodiment of the present inventive concept.

FIG. 3 is a flowchart showing a processing method according to an exemplary embodiment of the present inventive concept.

FIG. 4 is a view showing a structured illumination microscope according to an exemplary embodiment of the present inventive concept.

### DETAILED DESCRIPTION OF THE EXEMPLARY EMBODIMENTS

Exemplary embodiments of present inventive concept will be described more fully hereinafter with reference to the accompanying drawings.

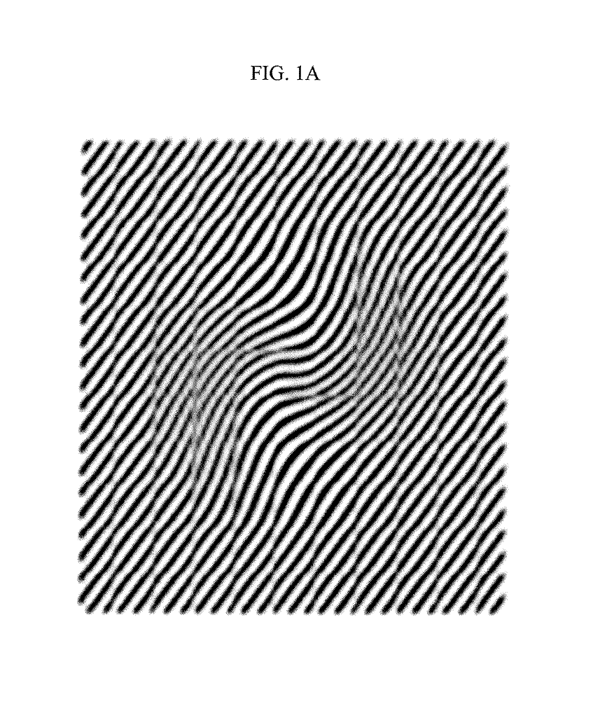

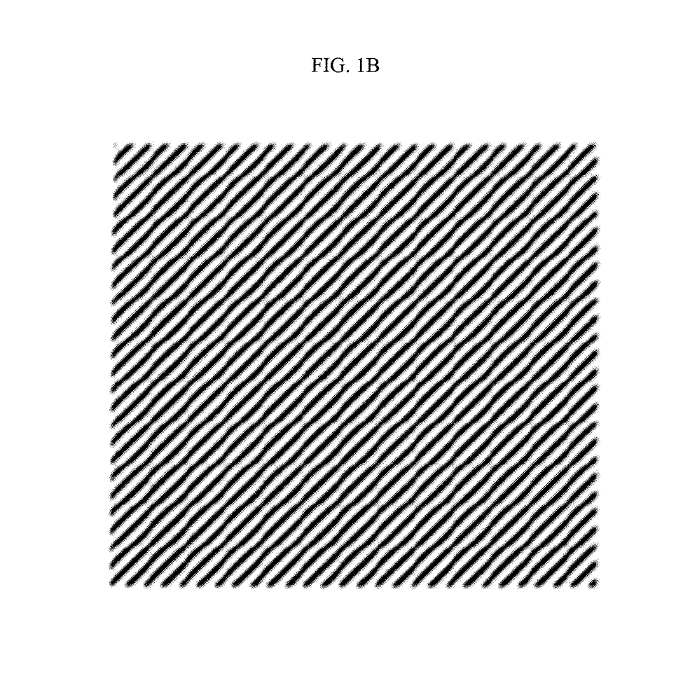

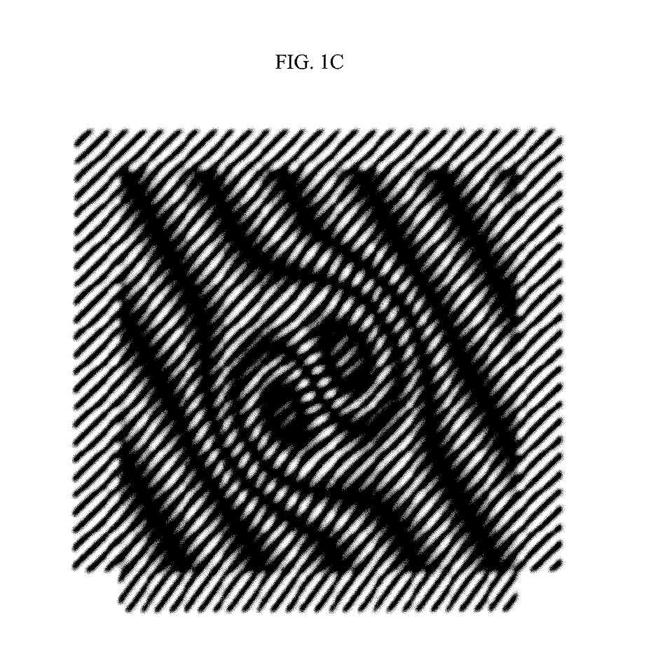

A method for processing an image of an observation object by using structured illumination microscopy will be described with reference to FIGS. 1A, 1B, and 1C, in a comparative example. FIG. 1A is a view showing an observation object in a comparative example. FIG. 1B is a view showing a lattice pattern in a comparative example. FIG. 1C is a view showing an interference pattern in a comparative example.

The observation object shown in FIG. 1A includes a pattern that is smaller than the resolution of a general microscope, such that an image may appear blurred. Information for the lattice pattern shown in FIG. 1B is a pattern known in advance by the user.

Overlapping the observation object and the lattice pattern will generate the interference pattern shown. The generated interference pattern is referred to as a moiré pattern.

Even if the observation object and the lattice pattern each include a pattern that is smaller than the resolution of the microscope, the interface pattern may still be observed. If the information of the interference pattern is detected, the information of the observation object may be reversely calculated by using the information of the lattice pattern, which is known by the user.

In this case, a resolution higher than that of the general microscope may be achieved by reverse calculating the information of the observation object by using information from changing the phase of the interference pattern on several images of the observation object. However, here, the resolution in a z-axis direction may not be as high as the resolution in the x-axis and y-axis directions.

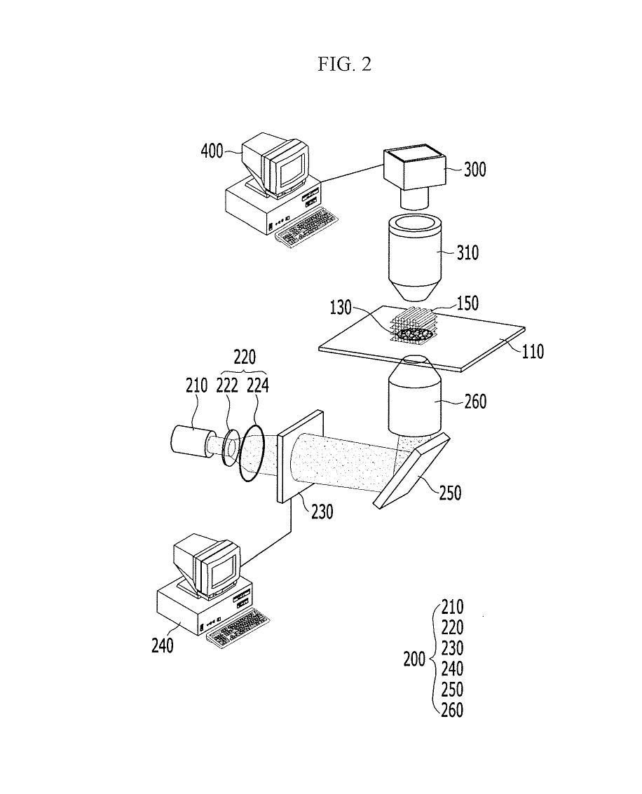

A structured illumination microscope according to an exemplary embodiment of the present inventive concept will be described with reference to FIG. 2.

FIG. 2 is a view showing a structured illumination microscope according to an exemplary embodiment of the present inventive concept.

The structured illumination microscope according to an exemplary embodiment of the present inventive concept includes a holographic image generator 200 that generates a holographic image 150, an image sensor 300 that senses an image, and an image processor 400 that recovers the image. Further, the holographic image includes information known by the user. Hereinafter, the word holographic may be interchangeable with the word hologram.

The holographic image generator 200 may include a light source 210 that provides light, a beam expander 220 to expand a width of a beam of light, a spatial light modulator 230 to generate the holographic image 150, and a controller 240. The controller 240 may transmit a signal for generating the holographic image 150 to the spatial light modulator 230.

The light source 210 supplies light having coherence. The coherence means that two waves can naturally interfere with each other, and there are temporal coherence and spatial coherence. For example, the light source 210 may include a laser. The laser amplifies an input signal and emits more light while the light is repeatedly reflected inside an amplifier and a stimulated emission is repeatedly generated, and the laser is a light source having high temporal and spatial coherence. As another example, the light source 210 may include a light emitting diode (LED) and a pin hole where the light supplied from the light emitting diode (LED) passes through. The pin hole may include a small hole with a circular shape, and the pin hole may be positioned at a section where the light is supplied from the light emitting diode (LED). For example, a size of the pin hole may be about the size of a hole pierced by a needle tip. Further, the light supplied from the light emitting diode (LED) does not have coherence. However, the light has coherence while passing through the pin hole.

The beam expander 220 is positioned at a section where the light is emitted from the light source 210. The beam expander 220 may convert a thin parallel light beam, such as the light emitted from the laser, into a thick parallel light beam. The beam expander 220 may include two lenses. The beam expander 220 may include a first lens 222 effusing the light supplied from the light source 210 to expand the beam width, and a second lens 224 converting the light transmitted through the first lens 222 into the parallel light (e.g., parallel rays of light).

The spatial light modulator 230 spatially modulates an amplitude or a phase of the light passing through the beam expander 220 to generate the holographic image 150. The spatial light modulator 230 may include a transmissive spatial light modulator. For example, the transmissive spatial light modulator may include a liquid crystal panel.

The controller 240 generates a signal that controls the spatial light modulator 230. The signal that controls the spatial light modulator 230 is transmitted to the spatial light modulator 230 by the controller 240. The controller 240 may transmit the signal to generate the holographic image 150 to the spatial light modulator 230. The controller 240 may variously change the signal to variously change the holographic image 150. For example, the controller 240 may change the signal to rotate the holographic image 150 in a predetermined direction. In a structured illumination microscope, while physically rotating the lattice pattern, various interference patterns are generated. In the present exemplary embodiment of the present inventive concept, without the physical rotation, the various interference patterns may be generated while rotating the holographic image 150 through the signal change generated by the controller 240.

The structured illumination microscope according to an exemplary embodiment of the present inventive concept may further include a stage 110 and an observation object 130 disposed on the stage 110. Also, the holographic image 150 generated by the holographic image generator 200 overlaps the observation object 130. In an exemplary embodiment of the present inventive concept, the observation object 130 may overlap the holographic image 150.

The holographic image generator 200 may further include a reflection member 250. The reflection member 250 may control the generation of the position of the holographic image 150. The holographic image 150 generated by the spatial light modulator 230 is reflected by the reflection member 250 to be disposed on the stage 110. For example, the holographic image 150 may be disposed above the stage 110. In this case, the holographic image 150 entirely overlaps the observation object 130.

The holographic image generator 200 may further include a condensing lens 260. The condensing lens 260 may control a size of the holographic image 150. For example, the holographic image 150 generated by the spatial light modulator 230 is reduced while passing through the condensing lens 260. As the size of the holographic image 150 is reduced, the resolution is increased. In this case, when trying to overlap the holographic image 150 with the entire observation object 130, it is desirable that the size of the holographic image 150 is larger than a size of the observation object 130.

The image sensor 300 may sense an interference image generated from overlapping the observation object 130 with the holographic image 150. The image sensor 300 may include a device converting the image into an electrical signal such as a charged-coupled device (CCD) camera. The image sensor 300 may sense the interference image, and the image sensor 300 may transmit the information of the interference image to the image processor 400.

Further, an objective and eyepiece lens 310 may be interposed between the stage 110 and the image sensor 300. The objective and eyepiece lens 310 may magnify the interference image generated by the overlapping of the observation object 130 and the holographic image 150, and the objective and eyepiece lens 310 transmit a magnified image of the interference image to the image sensor 300.

The image processor 400 receives the holographic image 150 and the interference image to obtain the image of the observation object 130. The image processor 400 may receive the information for the interference image from the image sensor 300. The image processor 400 may receive the information for the holographic image 150 from the controller 240 of the holographic image generator 200. For example, the image processor 400 may include a tablet or a personal computer.

Similar to the discussion relating to FIGS. 1A, 1B and 1C, if the information for the interference pattern is sensed by the image sensor 300, the information for the observation object 130 may be reversely calculated and obtained by using the information of the holographic image 150, which is already known by the user. Accordingly, when it is difficult to obtain the information of the observation object 130 through the general microscope, the information of the observation object 130 may be obtained by overlapping the observation object 130 with the holographic image 150 to sense the information of the interference image, according to the present exemplary embodiment of the present inventive concept. As a result, the resolution of the microscope may increase.

Also, in the present exemplary embodiment of the present inventive concept, by overlapping the observation object 130 with the three-dimensional holographic image 150, the interference pattern is sensed by the image sensor 300 as a three-dimensional image. Accordingly, greater resolution is achieved in the z-axis direction, as well as in the x-axis and y-axis directions.

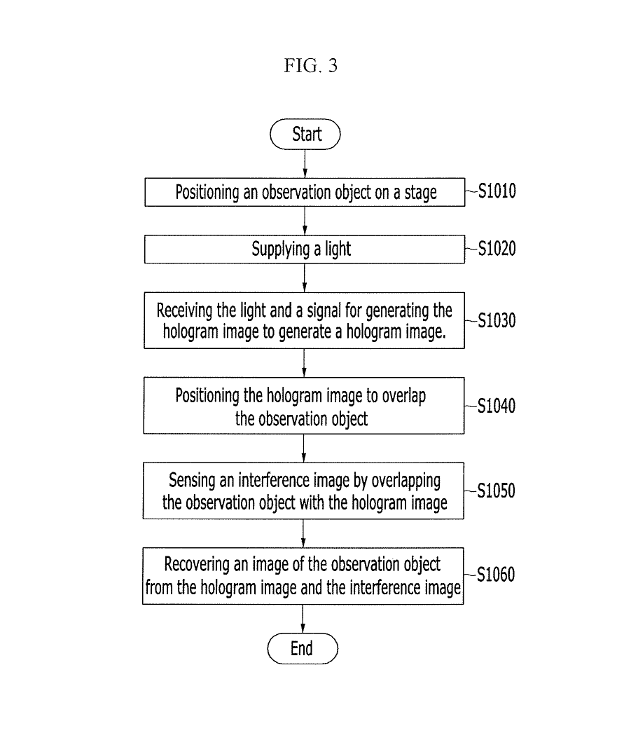

Next, an image processing method using the structured illumination microscope according to an exemplary embodiment of the present inventive concept will be described with reference to FIG. 2 and FIG. 3.

FIG. 3 is a flowchart showing an image processing method according to an exemplary embodiment of the present inventive concept.

The image processing method, according to an exemplary embodiment of the present inventive concept may include positioning the observation object 130 on the stage 110 (S1010).

The light is supplied by driving the light source 210 (S1020). The light supplied from the light source 210 may have coherence. For example, the light source 210 may include the laser. The width of the beam of light supplied from the light source 210 is expanded while passing through the beam expander 220.

The light expanded by the beam expander 220 is transmitted to the spatial light modulator 230. The controller 240 transmits the signal for generating the holographic image to the spatial light modulator 230. The spatial light modulator 230 receives the light and the signal for generating the holographic image 150. The spatial light modulator 230 generates the holographic image 150 based on the received light and the signal for generating the holographic image 150 (S1030).

Further, the reflection member 250 reflects the holographic image 150 generated by the spatial light modulator 230 to position the holographic image 150 so that the holographic image 150 is disposed above the stage 110 (S1040).

The observation object 130 may be positioned on the stage 110, and the holographic image 150 may overlap the observation object 130. In this case, the holographic image 150 overlaps the entire observation object 130. If the holographic image 150 and the observation object 130 overlap one another, the interference image is generated.

The condensing lens 260 may be disposed between the reflection member 250 and the stage 110. In this case, the condensing lens 260 may reduce the size of the holographic image 150, thereby increasing the resolution. Further, the size of the reduced holographic image 150 may be larger than that of the observation object 130 so that the holographic image 150 may overlap the entire observation object 130.

Further, in an exemplary embodiment of the present, a pattern direction, size and a depth of the holographic image 150 may be changed.

The image sensor 300 senses the interference image generated by the overlapping of the observation object 130 and the holographic image 150 (S1050). The image sensor 300 may convert the interference image into the electrical signal to transmit the information of the interference image to the image processor 400.

In addition, the objective and eyepiece lens 310 may be disposed between the stage 110 and the image sensor 300. The image sensor 300 may sense the interference image magnified by the objective and eyepiece lens 310.

The image processor 400 receives the holographic image 150 and the interference image to recover the image of the observation object 130 (S1060).

The image processor 400 receives the information of the interference image from the image sensor 300. In addition, the image processor receives information of the holographic image 150 from the controller 240 of the holographic image generator 200. Then, the information of the observation object 130 is calculated, thereby recovering a high resolution image of the observation object 130.

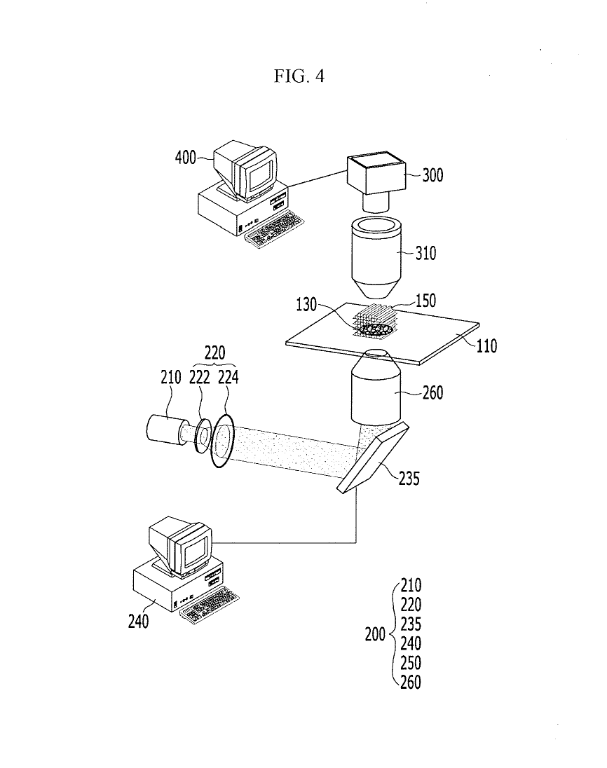

Next, the structured illumination microscope according to an exemplary embodiment of the present inventive concept will be described with reference to FIG. 4.

The structured illumination microscope according to an exemplary embodiment of the present inventive concept shown in FIG. 4 has parts substantially the same as that of the structured illumination microscope according to an exemplary embodiment of the present inventive concept shown in FIG. 2 such that the description thereof is omitted. In the present exemplary embodiment of the present inventive concept, the spatial light modulator may include a reflective spatial light modulator, which is different from a previous exemplary embodiment of the present inventive concept, and this will be described in detail later.

FIG. 4 is a view showing a structured illumination microscope according to an exemplary embodiment of the present inventive concept.

The structured illumination microscope according to an exemplary embodiment of the present inventive concept may include the holographic image generator 200 that generates the holographic image 150, the image sensor 300 that senses the image, and the image processor 400 that recovers the image.

The holographic image generator 200 may include the light source 210 that provides light, the beam expander 220 that expands the width of the beam of the light, a spatial light modulator 235 that generates the holographic image 150, and the controller 240. The controller 240 may transmit the signal that generates the holographic image to the spatial light modulator 235.

The spatial light modulator 235 spatially modulates the amplitude or the phase of the light passing through the beam expander 220 to generate the holographic image 150. The spatial light modulator 235 may include the reflective spatial light modulator. For example, the spatial light modulator 235 may include a Liquid Crystal on Silicon (LCoS) panel or a Digital Micromirror Device (DMD) panel. Further, the LCoS panel may use a reflection chip of a Digital Light Processing (DLP) type while using the liquid crystal panel. The DMD panel is a device in which micromirrors are planted at a predetermined interval on a silicon wafer to control a reflection of light through the mirrors, thereby representing the image.

In a previous exemplary embodiment of the present inventive concept, the reflection member (e.g., 250 of FIG. 2) is used to provide the holographic image 150 generated by the spatial light modulator (e.g., 230 of FIG. 2) at the position overlapping the observation object 130. In the present exemplary embodiment of the present inventive concept, since the spatial light modulator 235 includes the reflective spatial light modulator, the separate reflection member (e.g., 250 of FIG. 2) of the previous exemplary embodiment of the present inventive concept might not be used. In the present exemplary embodiment of the present inventive concept, the spatial light modulator 235 is disposed at the section where the reflection member (e.g., 250 of FIG. 2) of the previous exemplary embodiment of the present inventive concept is disposed. The holographic image generated by the spatial light modulator 235 is disposed at the position overlapping the observation object 130.

While present disclosure has been particularly shown and described with reference to the exemplary embodiments of the present inventive concept, it is to be understood that the present inventive concept is not limited to the disclosed exemplary embodiments, but is intended to cover various modifications and equivalent arrangements included within the spirit and scope of the present inventive concept as defined by the following claims.

What is claimed is:

1. A structured illumination microscope comprising:
a holographic image generator that generates a holographic image at a position overlapping an observation object;
an image sensor that senses an interference image generated by overlapping the observation object with the holographic image; and
an image recovery processor that recovers an image of the observation object by comparing received data of the holographic image to received data of the interference image.

2. The structured illumination microscope of claim 1, wherein the holographic image generator includes:
a light source that provides light;
a beam expander that expands a beam width of the light from the light source;
a spatial light modulator that receives the expanded light to generate the holographic image; and
a controller that transmits a signal to the spatial light modulator to generate the holographic image.

3. The structured illumination microscope of claim 2, wherein the holographic image generator further includes a reflector that reflects the light from the light source to overlap the holographic image with the observation object.

4. The structured illumination microscope of claim 3, wherein the holographic image generator further includes a condensing lens that reduces a size of the holographic image.

5. The structured illumination microscope of claim 2, wherein the light source includes a laser.

6. The structured illumination microscope of claim 2, wherein the light source includes:
a light emitting diode (LED); and
a pin hole where the light from the LED passes through.

7. The structured illumination microscope of claim 2, wherein the beam expander includes:
a first lens that effuses the light supplied from the light source to expand the beam width; and
a second lens that converts the light transmitted from the first lens into parallel light.

8. The structured illumination microscope of claim 2, wherein the spatial light modulator includes a transmissive spatial light modulator.

9. The structured illumination microscope of claim 8, wherein the transmissive spatial light modulator includes a liquid crystal panel.

10. The structured illumination microscope of claim 2, wherein the spatial light modulator includes a reflective spatial light modulator.

11. The structured illumination microscope of claim 10, wherein the reflective spatial light modulator includes a Liquid Crystal on Silicon (LCoS) panel or a Digital Micromirror Device (DMD) panel.

12. The structured illumination microscope of claim 1, further comprising an objective and eyepiece lens that magnifies the interference image that is transmitted to the image sensor.

13. An image processing method comprising:
positioning an observation object on a stage;
supplying a light;
receiving the light and a signal for generating a holographic image to generate the holographic image;
positioning the holographic image to overlap the observation object;
sensing an interference image generated by overlapping the observation object with the holographic image; and
recovering an image of the observation object by comparing received data of the holographic image to received data of the interference image.

14. The image processing method of claim 13, further comprising changing at least one of a pattern direction, a size, and a depth of the holographic image.

15. The image processing method of claim 13, further comprising expanding a beam width of the light.

16. The image processing method of claim 15, further comprising reducing a size of the holographic image.

17. The image processing method of claim 16, further comprising magnifying the interference image.

18. The image processing method of claim 13, wherein a spatial light modulator generates the holographic image.

19. The image processing method of claim 18, wherein the spatial light modulator includes a transmissive spatial light modulator or a reflective spatial light modulator.

20. The image processing method of claim 18, wherein the spatial light modulator includes at least one of a liquid crystal panel, a Liquid Crystal on Silicon (LCoS) panel, and a Digital Micromirror Device (DMD) panel.
